(19) United States
(12) Patent Application Publication
(10) Pub. No.: US 2009/0085830 A1
(43) Pub. Date: Apr. 2, 2009

(54) Multiple Video Display Device, Screen Forming Program and Computer Readable Recording Medium

(75) Inventors: Akira Imai, Nara (JP); Tomoo Takatani, Nara (JP); Hiroshi Fukushima, Nara (JP)

Correspondence Address: NIXON & VANDERHYE, PC, 901 NORTH GLEBE ROAD, 11TH FLOOR, ARLINGTON, VA, 22203, US

(73) Assignee: SHARP KABUSHIKI KAISHA, Osaka-shi, Osaka (JP)

(21) Appl. No.: 12/282,053

(22) PCT Filed: Jan. 18, 2007
(86) PCT No.: PCT/JP2007/050704

§ 371 Date: Sep. 8, 2008

(30) Foreign Application Priority Data
Mar. 17, 2006 (JP) 2006-075681

(51) Int. Cl. G09G 5/00

(52) U.S. Cl. 345/1.1

(57) ABSTRACT

A dual-view liquid crystal display device (1) includes: screen scaling-down sections (32, 42) for forming child screens (11a, 12a), i.e., screens obtained by scaling down parent screens (11, 12); and screen combining sections (33, 34) for combining the child screens (12a, 11a) with the parent screens (11, 12), respectively. This makes it possible to know the content of one screen while viewing the other screen.

### TECHNICAL FIELD

The present invention relates to a multiple video display device capable of displaying different images with respect to a plurality of points of view.

### BACKGROUND ART

A dual-view display device is a display device with a single display panel that simultaneously displays a plurality of images, each of which can be observed by looking at the display panel in different directions.

Such a dual-view display device is realized, for example, as a 3-D display device, obtained by combining viewing angle control means such as a parallax barrier with a display panel, an example of which is disclosed in Patent Document 1. FIG. 13 is a schematic diagram showing an arrangement of a display section 20 of a conventional dual-view display device. As shown in FIG. 13, the display section 20 includes a display panel 23 and a parallax barrier 24. The display panel 23 includes a liquid crystal layer 21 and a color filter 22. The parallax barrier 24, provided on an outer side of the color filter 22, serves as viewing angle control means. The liquid crystal layer 21 and the parallax barrier 24 have outer sides in contact with a transparent substrate 25, on an outer side of which a polarization plate 26 is further provided.

The parallax barrier 24 gives a specific viewing angle, with the result that in cases where the display section 20 is seen from a specific observation area, only a screen corresponding to the observation area is viewed. FIG. 14 explains the appearance of a screen of the display section 20. As shown in FIG. 14, for example, a user A who is in a right-side observation area views a television screen 27 showing a map, and a user B who is in a left-side observation area views a television screen 28.

Next, an arrangement for forming a screen to be displayed by the display section 20 is described with reference to FIG. 15. FIG. 15 is a schematic diagram showing an arrangement of a conventional dual-view display device 50. As shown in FIG. 15, the dual-view display device 50 includes a left-display screen forming section 51, a right-display screen forming section 52, and a right-and-left screen combining section 53. The left- and right-display screen forming sections 51 and 52 form a screen for use in display on the left side and a screen for use in display on the right side, respectively, and the right-and-left screen combining section 53 combines the screens thus formed. The screens thus combined are displayed by the display section 20 under control of a display control section 54.

By thus displaying different screens with a single display device and allowing a user to view only a screen that he/she would like to view, it is possible to achieve a reduction in cost and installation space in comparison with the case of installation of a plurality of display devices, and to prevent the user from viewing a screen that he/she would not like to view.

[Patent Document 1] Japanese Unexamined Patent Application Publication No. 206089/2004 (Tokukai 2004-206089; published on Jul. 22, 2004)

### DISCLOSURE OF THE INVENTION

However, the conventional arrangement suffers from such a bad feature of a dual-view display device that a user has no idea of what is being viewed by another user who is an observation area different from his/her own and therefore has a difficulty in carrying out a conversation about the screen that his/her partner is viewing.

For example, in the case of operation of a dual-view display device loaded into a vehicle, a user who is taking the driver's seat is likely to be used to operating the dual-view display device, but a user who is sitting in the front passenger seat is unlikely to be used to the operation. Therefore, when the user who is sitting in the front passenger set would like to switch to a screen that he/she would like to view, he/she needs to ask the driver how to operate the dual-view display device or ask the driver to operate the dual-view display device.

In so doing, because the conventional arrangement does not allow the driver to view the screen that his/her passenger is viewing, the driver has a difficulty in confirming whether or not the passenger is operating the dual-view display device accurately according to the driver's instructions, or in confirming whether or not the driver's operation allows the passenger to view a screen that the passenger would like to view.

Further, in the case of a presentation with use of a dual-view display device, i.e., in cases where a trader talks business with a client, it is preferable that the trader view a screen that the trader is supposed to view and simultaneously view a screen that the client is viewing. That is, it is preferable that the trader talk business while confirming whether or not the trader is showing the client an appropriate screen (or the trader is not showing the client an inappropriate screen). However, the conventional arrangement cannot make it possible to make such a presentation.

The present invention has been made in view of the foregoing problems, and it is an object of the present invention to provide a multiple video display device that makes it possible to, in a situation where a screen that can be viewed in a direction is viewed in that direction, know the content of another screen that can be viewed in another direction.

A multiple video display device according to the present invention is a multiple video display device for displaying a first screen with respect to a first direction and a second screen with respect to a second direction, including: a content display image forming section for forming a content display image indicative of content of the second screen; and a screen combining section for incorporating, into the first screen, the content display image formed by the content display image forming section.

According to the foregoing arrangement, the content display image forming section forms a content display image indicative of content of the second screen, and the screen combining section incorporates the content display image into the first screen. This makes it possible to know the content of the second screen while viewing the first screen from the direction of a first point of view.

Therefore, in cases where the first screen and the second screen are different from each other, a user who is looking from the direction of a first point of view can know what is being viewed by a different user who is looking from the direction of a second point of view, and can thereby carry out a smooth and comfortable conversation with the different user.

### BRIEF DESCRIPTION OF THE DRAWINGS

FIG. 1 is a schematic diagram showing arrangements of left- and right-display screen forming sections of a dual-view liquid crystal display device according to an embodiment of the present invention.

FIG. 2 is a schematic diagram showing an arrangement of a dual-view liquid crystal display device according to an embodiment of the present invention.

FIG. 3 is a schematic diagram showing a display style of a child screen.

FIG. 4 is a schematic diagram showing another display style of a child screen.

FIG. 5 is a schematic diagram showing still another display style of a child screen.

FIG. 6 shows an example of a change in the size of a child screen on a parent screen.

FIG. 7 shows an example of a change in the position of a child screen on a parent screen.

FIG. 8 is a flow char showing the flow of a process in a dual-view liquid crystal display device according to an embodiment of the present invention.

FIG. 9 is a schematic diagram showing a display style of a child screen.

FIG. 10 is a schematic diagram showing display styles of a child screen and a mode display image.

FIG. 11 is a schematic diagram showing a display style of a child screen.

FIG. 12 is a flow chart showing a modified example of the flow of a process in a display device 1.

FIG. 13 is a schematic diagram showing an arrangement of a display section of a conventional dual-view display device.

FIG. 14 explains the appearance of a screen of the display section of the conventional dual-view display device.

FIG. 15 is a schematic diagram showing an arrangement of the conventional dual-view display device.

### REFERENCE NUMERALS

1 Dual-view liquid crystal display device (multiple video display device)
2 Source mode setting section (content display image selecting section)
9 Input section
11 Parent screen (first screen, second screen)
11a Child screen (scaled-down image)
12 Parent screen (first screen, second screen)
12a Child screen (scaled-down image)
31 Screen forming section
32 Screen scaling-down section (content display image forming section, screen scaling-down section)
33 Screen combining section (screen combining section)
42 Screen scaling-down section (content display image forming section, screen scaling-down section)
43 Screen combining section (screen combining section)

### BEST MODE FOR CARRYING OUT THE INVENTION

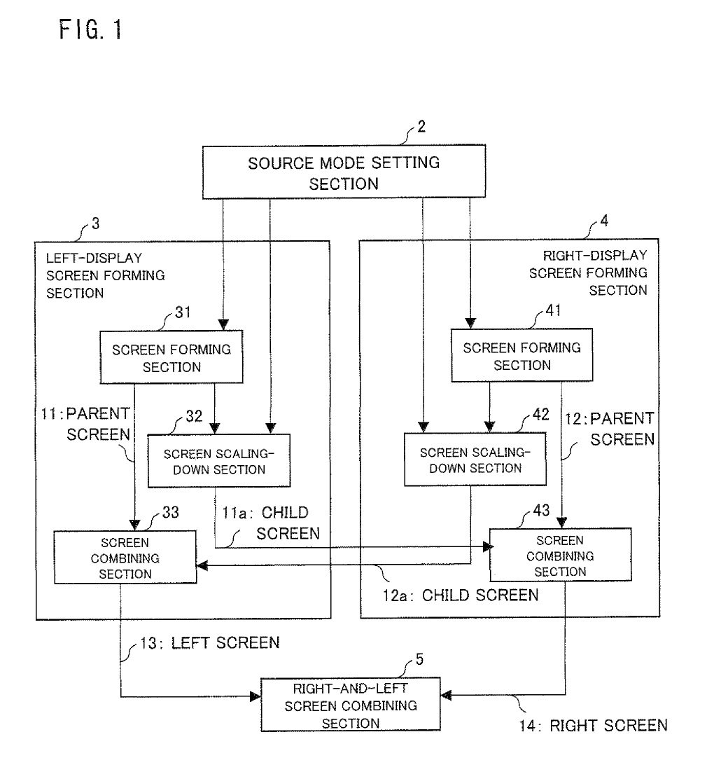

An embodiment of the present invention will be described below with reference to FIGS. 1 through 12.

[1. Arrangement of a Dual-view Liquid Crystal Display Device 1]

A dual-view liquid crystal display device 1 of the present embodiment (such a device being hereinafter referred to as “display device 1”) allows a user who is looking at a display section of the display device 1 from the left side (in a first direction) to view a screen for use in display on the left side (first screen), and allows a user who is looking at the display section from the right side (in a second direction) to view a screen for use in display on the right side (second screen).

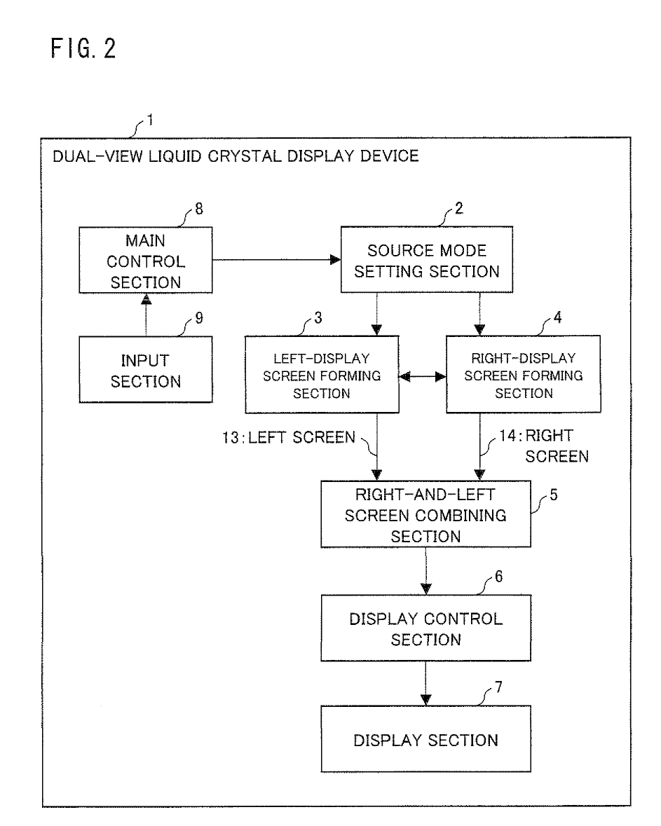

FIG. 2 is a schematic diagram showing an arrangement of the display device 1. As shown in FIG. 2, the display device 1 (multiple video display device) includes a source mode setting section 2 (content display image selecting section), a left-display screen forming section 3, a right-display screen forming section 4, a right-and-left screen combining section 5, a display control section 6, and a display section 7. Further, the display device 1 may contain a receiving device (not shown) for receiving a television broadcast and a device (not shown) having a car navigation function, or may include an interface (not shown) for connecting the display device 1 to these devices.

The source mode setting section 2 generates, in accordance with a user's instruction inputted via an input section 9, a screen forming command that prescribes the display content of a screen for use in display on the left side (such a screen being hereinafter referred to as “left screen”) and a screen for use in display on the right side (such a screen being hereinafter referred to as “right screen”), and controls the left- and right-display screen forming sections 3 and 4 by outputting the screen forming command. The screen forming command will be described later.

The left- and right-display screen forming sections 3 and 4 form a left screen and a right screen in accordance with the screen forming command outputted from the source mode setting section 2 and output the screens to the right-and-left screen combining section 5, respectively. The left- and right-display screen forming sections 3 and 4 will be described later in detail.

The right-and-left screen combining section 5 combines the screens respectively outputted from the left- and right-display screen forming sections 3 and 4, thereby forming a synthetic screen for use in dual-view display. The method for combining screens is described, for example, in Patent Document 1. The right-and-left screen combining section 5 outputs the synthetic screen to the display control section 6.

The display control section 6 controls the display section 7 so that the display section 7 displays the synthetic screen outputted from the right-and-left screen combining section 5.

The display section 7 is a liquid crystal display section that allows the left screen to be viewed from the left side and the right screen from the right side. That is, the display section 7 is capable of a dual-view display. The display section 7 is not particularly limited in arrangement. However, for example, the display section 7 includes a display panel and a parallax barrier. The display panel includes a liquid crystal layer and a color filter, and the parallax barrier is provided on an outer side of the color filter.

[2. Arrangements of the Left- and Right-display Screen Forming Sections 3 and 4]

FIG. 1 is a schematic diagram showing arrangements of the left- and right-display screen forming sections 3 and 4.

As shown in FIG. 1, the left-display screen forming section 3 includes a screen forming section 31, a screen scaling-down section 32 (content display image forming section, screen scaling-down section), and a screen combining section 33 (screen combining section). Similarly, the right-display screen forming section 4 includes a screen forming section 41, a screen scaling-down section 42 (content display image forming section, screen scaling-down section), and a screen combining section 43 (screen combining section).

The screen forming section 31 forms a left parent screen 11 (main screen, first/second screen) in accordance with the screen forming command outputted from the source mode setting section 2. Data for forming the parent screen 11 may be obtained or generated from a television tuner (not shown) or a car navigation device (not shown) built in the display device 1, or may be obtained from an external image providing device (not shown) connected to the display device 1. The screen forming section 31 outputs the parent screen 11 to the screen scaling-down section 32 and the screen combining section 33.

The screen scaling-down section 32 forms, in accordance with the patent screen 11 outputted from the screen forming section 31, a child screen 11a (subscreen, content display image) that is a scaled-down version of the patent screen. The rate at which the parent screen is scaled down is prescribed by the screen forming commend outputted from the source mode setting section 2. The screen scaling-down section 32 outputs the child screen 11a to the screen combining section 43 of the right-display screen forming section 4.

Meanwhile, in the right-display screen forming section 4, the screen forming section 41 and the screen scaling-down section 42 work the same way as the screen forming section 31 and the screen scaling-down section 32. Moreover, the screen scaling-down section 42 forms a child screen 12a (content display image) and outputs it to the screen combining section 33 of the left-display screen forming section 3.

The screen combining section 33 forms a left screen 13 by incorporating, into the parent screen 11 outputted from the screen forming section 31, the child screen 12a outputted from the screen scaling-down section 42. The position of the child screen with respect to the patent screen is prescribed by the screen forming command outputted from the source mode setting section 2. The incorporation of the child screen into the parent screen only needs to be carried out by a so-called picture-in-picture method, but is not limited to the method. The screen combining section 33 outputs data indicative of the left screen 13 to the right-and-left screen combining section 5.

Similarly, the screen combining section 43 forms a right screen 14 by incorporating, into the patent screen 12 (main screen, first/second screen) outputted from the image forming section 41, the child screen 11a outputted from the screen scaling-down section 32. The screen combining section 43 outputs data indicative of the right screen 14 to the right-and-left screen combining section 5.

[3. Method for Configuring the Settings in the Source Mode Setting Section 2]

The following explains a method for configuring the settings for a parent screen and a child screen in the source mode setting section 2. The source mode setting section 2 generates a screen forming command in accordance with a user's instruction inputted via the input section 9. The screen forming command contains information indicative of the content of a parent screen, a child-screen forming command under which a child screen is formed, and information indicative of the rate at which the child screen is scaled down and the position of the child screen.

[3-1. Method for Configuring the Settings for a Parent Screen]

The content of a parent screen to be displayed on a left screen and the content of a parent screen to be displayed on a right screen are set independently of each other. For example, the left and right screens can be set as a television screen and a navigation screen, respectively. Alternatively, the left and right screens can be set so as to display pictures of different television channels. The source mode setting section 2 generates, in accordance with a user's instruction, a screen forming command containing information indicative of the display content of a parent screen.

[3-2. Method for Setting the Display Style of a Child Screen]

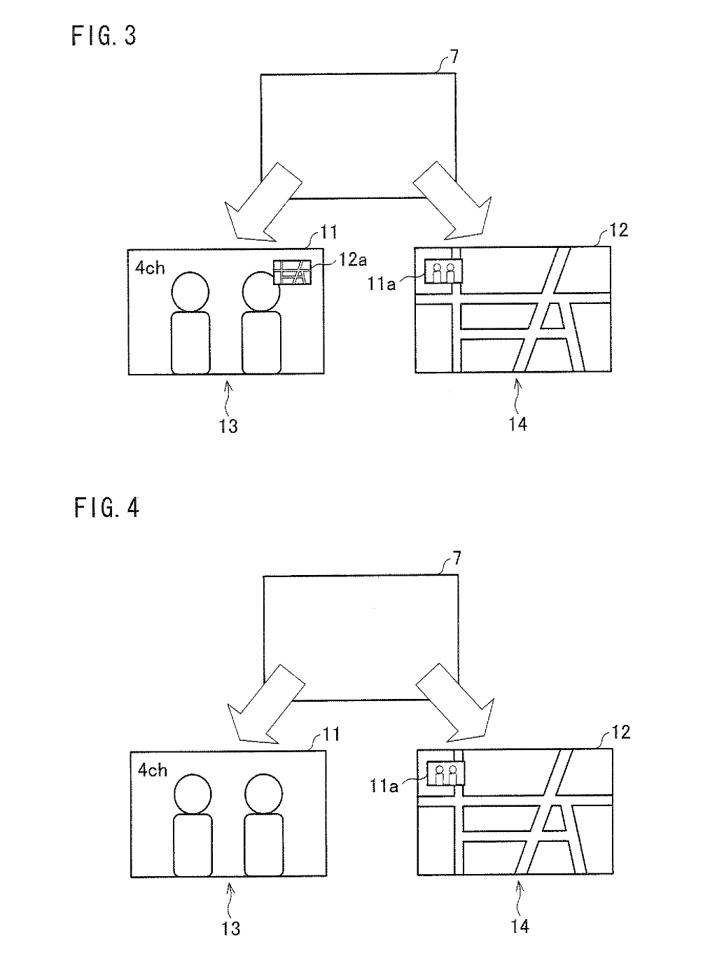

FIGS. 3 through 5 are schematic diagrams each showing the display style of a child screen.

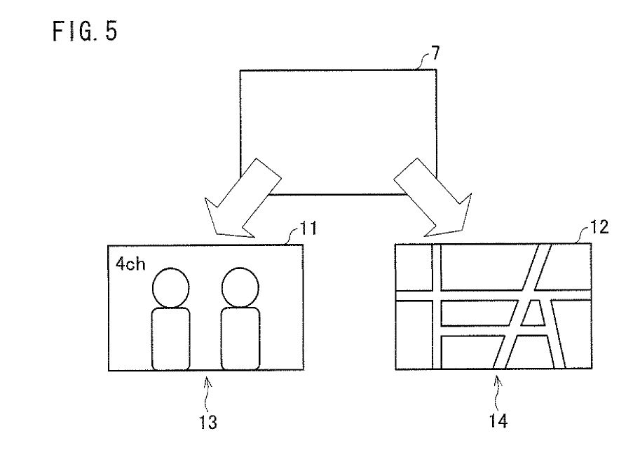

As shown in FIG. 3, it is possible to display child screens on both the left and right screens 13 and 14. As shown in FIG. 4, it is also possible to display a child screen on either of the left and right screens 13 and 14. In FIG. 4, only the right screen 14 displays the child screen 11a. Alternatively, as shown in FIG. 5, it is also possible to display no child screen on either of the left and right screens 13 and 14. The display style of a child screen is determined in accordance with a user's instruction inputted via the input section 9.

The source mode setting section 2 generates, in accordance with the user's instruction, a screen forming command containing a child-screen forming command. Examples of a method for using a child-screen forming command to indicate whether or not a child screen is formed include a method for indicating the necessity or nonnecessity of formation of a child screen by changing the value of a flag of a child-screen forming command. Specifically, the value only needs to be set to 1 in cases where a child screen is formed or to 0 when no child screen is formed. The source mode setting section 2 sets the value of the flag in accordance with a user's instruction.

[3-3. Method for Setting the Size and Display Position of a Child Screen]

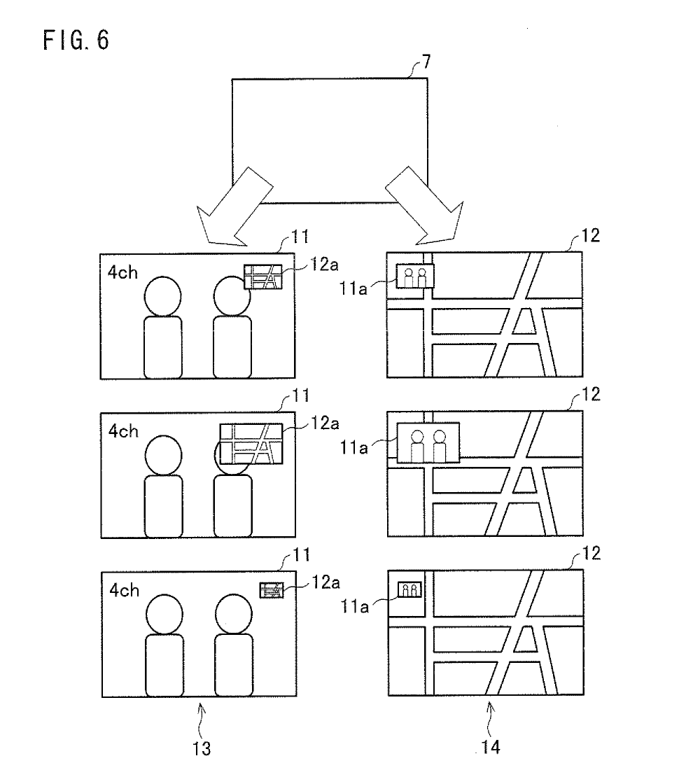

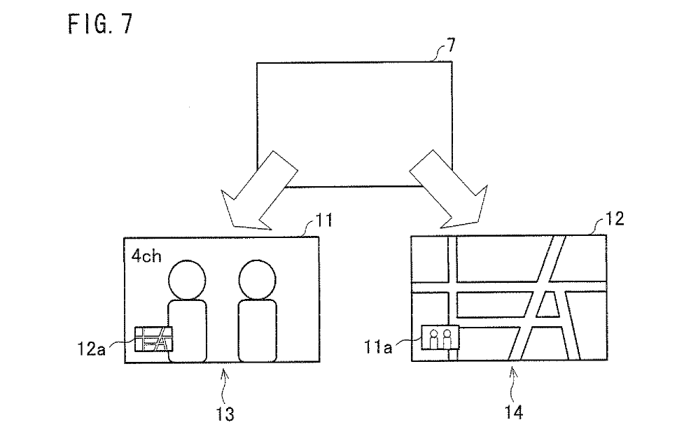

FIG. 6, showing an example of a change in size of a child screen on a parent screen, shows an example of a three-step change in size of each of the child screens 11a and 12a. FIG. 7, showing an example of a change in position of a child screen on a parent screen, shows an example where the child screens 11a and 12a are disposed in the lower left corners of the parent screens 12 and 11, respectively. As shown in FIGS. 6 and 7, it is preferable to make an arrangement capable of changing the size and position of a child screen.

The size and display position of a child screen are determined in accordance with a user's instruction inputted via the input section 9. This arrangement enables the user to view a child screen in a size and a position with which he/she feels most comfortable.

The source mode setting section 2 generates, in accordance with a user's instruction, a screen forming command containing information indicative of the rate at which a child screen is scaled down and the position of the child screen, thereby prescribing the size and position of the child screen on a parent screen.

The method for setting the size of a child screen is not particularly limited. For example, the size of a child screen may be set by providing a plurality of sizes of the child screen and by scaling up or down the child screen stepwise, or may be set by scaling up or down the child screen steplessly. Further, the size of a child screen may be changed by using an ordinary scaler IC.

Further, the method for setting the position of a child screen is not particularly limited, either. For example, the position of a child screen may be set by providing a plurality of display positions of the child screen and by allowing the user to select one of the display positions. The display position of a child screen is not particularly limited, either. For example, the display position of a child screen may be one of the four corners of a parent screen, or may be a midpoint of each side of the parent screen. Further, it is also possible to display the child screen in any position on the parent screen.

[4. Flow of a Process in the Display Device 1]

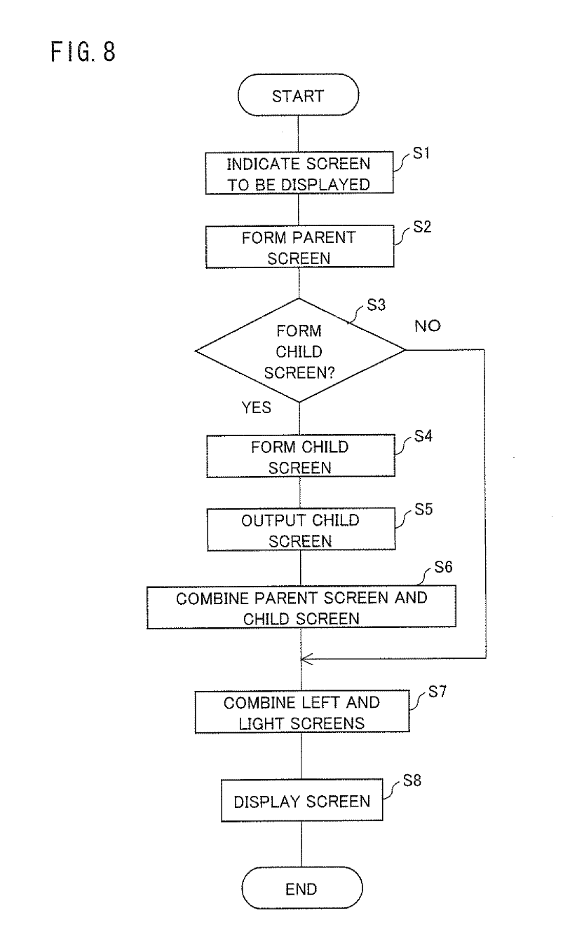

Next, the flow of a process in the display device 1 will be described with reference to FIG. 8. FIG. 8 is a flow chart showing the flow of a process in the display device 1.

As shown in FIG. 8, when the user selects, via the input section 9, the content of a screen to be displayed by the display device 1 (S1), the content of operation is transmitted to the source mode setting section 2 via a main control section 8.

The source mode setting section 2 generates, in accordance with the user's instruction, such a screen forming command as described above, and then outputs the screen forming command to each of the sections of the left- and right-display screen forming sections 3 and 4.

Upon receiving the screen forming command, the image forming sections 31 and 41 form parent screens 11 and 12 in accordance with the screen forming command, respectively (S2). Then, the screen forming sections 31 and 41 outputs the parent screens to the respective screen scaling-down sections 32 and 42 and the respective screen combining sections 33 and 43.

Upon receiving the screen forming command from the source mode setting section 2, each of the screen scaling-down sections 32 and 42 inspects the value of a flag of a child-screen forming command contained in the screen forming command (S3).

In cases where the value of the flag is 1, i.e., in cases where a child screen needs to be formed (YES in S3), the screen scaling-down sections 32 and 42 forms child screens 11a and 12a by scaling down, at the scale-down rates indicated by the screen forming command, the parent screens 11 and 12 outputted from the screen forming sections 31 and 41, respectively (S4).

Then, the screen scaling-down section 32 outputs the child screen 11a to the screen combining section 43, and the screen scaling-down section 42 outputs the child screen 12a to the screen combining section 33 (S5).

Upon receiving the parent screen 11 from the screen forming section 31 and the child screen 12a from the screen scaling-down section 42, the image combining section 33 forms a left screen 13 with incorporation of the child screen 12a into the parent screen 11 in accordance with the screen forming command outputted from the source mode setting section 2 (S6).

Further, upon receiving the parent screen 12 from the screen forming section 41 and the child screen 11a from the screen scaling-down section 32, the image combining section 43 forms a right screen 14 with incorporation of the child screen 11a into the parent screen 12 in accordance with the screen forming command outputted from the source mode setting section 2 (S6).

The image combining sections 33 and 43 output the left and right screens to the right-and-left screen combining section 5, respectively.

Meanwhile, in cases where the value of the flag is 0, i.e., in cases where no child screen needs to be formed (NO in S3), the screen scaling-down section 32 outputs, to the screen combining section 43, child-screen nonformation information indicating that no child screen is formed, and the screen scaling-down section 42 outputs the child-screen nonformation information to the screen combining section 33.

Upon receiving the parent screen 11 from the screen forming section 31 and the child-screen nonformation information from the screen scaling-down section 42, the screen forming section 33 outputs the parent screen 11 as a left screen 13 to the right-and-left screen combining section 5.

Upon receiving the parent screen 12 from the screen forming section 41 and the child-screen nonformation information from the screen scaling-down section 32, the screen forming section 43 outputs the parent screen 12 as a right screen 14 to the right-and-left screen combining section 5.

Upon receiving the left screen 13 from the screen combining section 33 and the right screen 14 from the screen combining section 43, the right-and-left screen combining section 5 combines the left and right screens 13 and 14 (S7), and then outputs a synthetic screen for use in display to the display control section 6.

Upon receiving the synthetic screen for use in display, the display control section 6 controls the display section 7 so that the display section 7 displays the synthetic screen (S8). This is the end of the series of steps.

[5. Effects of the Display Device 1]

The screen scaling-down sections 32 and 42 form the child screens 11a and 12a by scaling down the parent screens 11 and 12 formed by the screen forming sections 31 and 41, respectively, and the screen combining section 33 incorporates the child screen 12a into the parent screen 11 and the screen combining section 43 incorporates the child screen 11a into the parent screen 12. This makes it possible to know the content of a right (or left) screen while viewing a left (or right) screen from the left (or right) side.

Therefore, in cases where the left and right screens are different from each other, the content of one screen can be known while viewing the other screen. This allows a user who is viewing one screen to carry out a smooth and comfortable conversation with a user who is viewing the other screen.

[6. Modified Examples]

The present invention is not limited to the description of the embodiments above, but may be altered by a skilled person within the scope of the claims. An embodiment based on a proper combination of technical means disclosed in different embodiments is encompassed in the technical scope of the present invention.

The above description takes as an example a dual-view display device that differs in appearance between the left side and the right side. However, the present invention can be applied to a dual-view display device that differs in appearance between the upper side and the lower side. That is, the present invention can be applied to any dual-view display device that can show different screens in two different directions.

Further, the present invention can be applied not only to a display device that has a parallax barrier and a display section which includes a color filter and a liquid crystal layer, but also to any display device that has a display section capable of a dual-view display.

[6-1. Modified Example of a Display of a Child Screen]

According to the aforementioned arrangement, the source mode setting section 2 generates, in accordance with a user's instruction, a screen forming commend containing a child-screen forming command. However, the source mode setting section 2 may set a predetermined display style under predetermined conditions.

[6-1-1. Modified Example 1 of a Display of a Child Screen]

For example, there may be such a setting that no child screen is displayed in cases where the left and right screens are identical to each other (such a case being hereinafter referred to as “single-view mode”) and a child screen is displayed in cases where the left and right screens are different from each other (such a case being hereinafter referred to as “dual-view mode”).

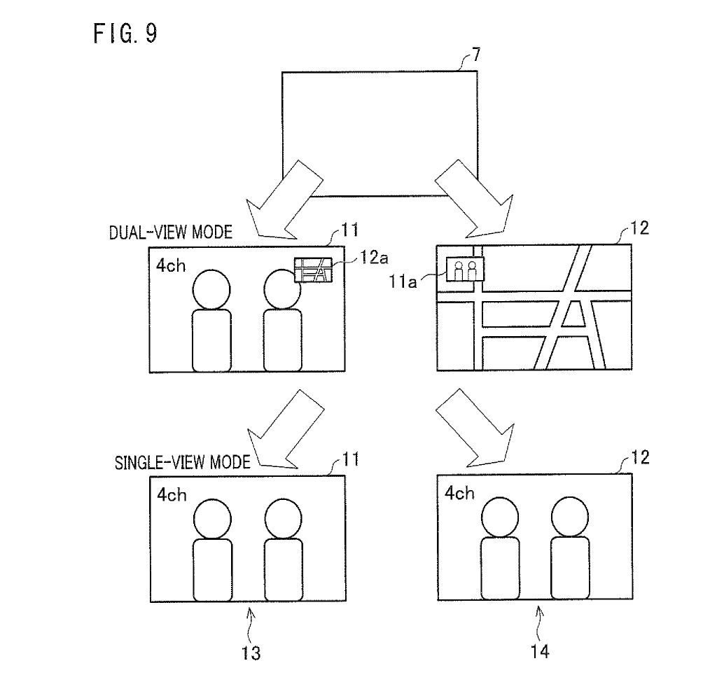

FIG. 9 is a schematic diagram showing the display style of a child screen. As shown in FIG. 9, whereas the child screens 11a and 12a are displayed in the dual-view mode (upper), neither of them is displayed in the single-view mode.

Whether the display device 1 is in the single-view mode or in the dual-view mode is determined by the source mode setting section 2. That is, in cases where the parent screens 11 and 12 are identical images, the source mode setting section 2 determines that the display device 1 is in the single-view mode, and in cases where the parent screens 11 and 12 are different images, the source mode setting section 2 determines that the display device 1 is in the dual-view mode.

In other words, the source mode setting section 2 includes a comparing section (not shown) for making a comparison between the display content of a left screen with the display content of a right screen, and determines, in accordance with a result of the comparison made by the comparing section, whether or not a child screen is displayed.

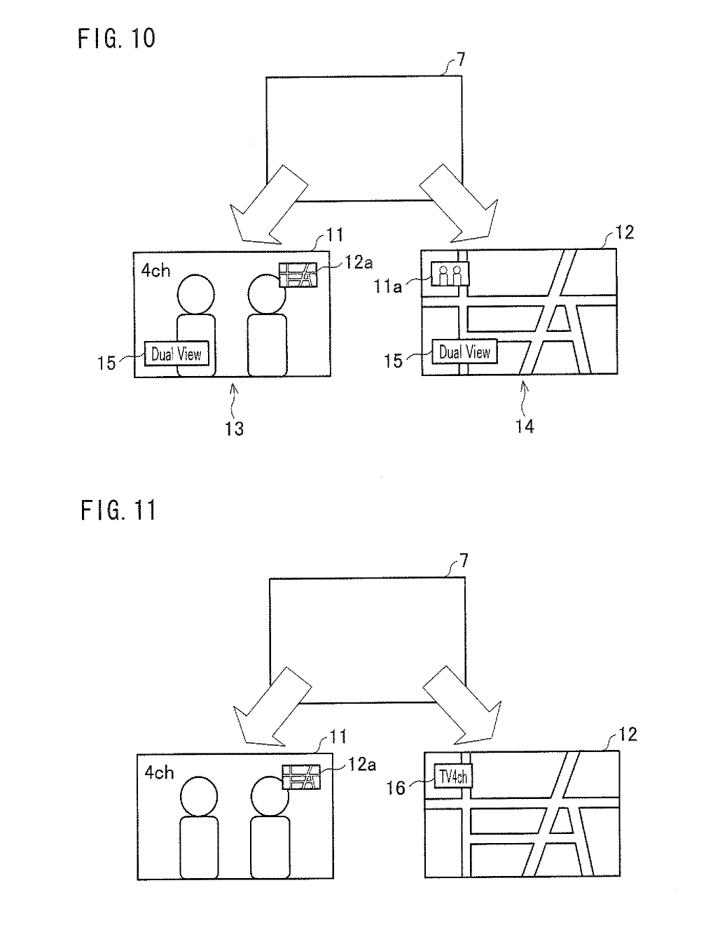

In determining whether the display device 1 is in the single-view mode or in the dual-view mode, the source mode setting section 2 may form a mode display image indicative of a result of the determination, and the mode display image may be displayed as a second child screen. FIG. 10 is a schematic diagram showing the display styles of a child screen and a mode display image. For example, as shown in FIG. 10, a mode display image 15 containing characters “Dual View” may be displayed as a second child screen together with a first child screen (scaled-down screen). The mode display image 15 is not particularly limited in display content, and may be a character or a figure as long as it is capable of a distinction between the single-view mode and the dual-view mode.

Image data indicative of a mode display image is stored in advance in a memory (not shown) provided in the display device 1. Upon receiving, from the source mode setting section 2, a command to display a mode display image, each of the screen combining sections 33 and 34 only needs to acquire image data indicative of a corresponding mode display image from the memory and incorporate the mode display image into the parent screen. It is preferable that the display position and size of a mode display image be able to be changed by a user. The display style of a mode display image can be changed in the same way as that of a first child screen.

[6-1-2. Modified Example 2 of a Display of a Child Screen]

Further, there is a case where it is prohibited by law or self-restraint to display some type of image. For example, Japan Automobile Manufacturers Association, Inc. exercises self-restraint on the content of images that display devices loaded into vehicles can display while the vehicles are moving.

In order to deal with such restrictions, it is preferable to provide an arrangement for determining, in accordance with whether or not a vehicle equipped with the display device 1 (hereinafter referred to as “display-device-equipped vehicle”) is moving or at rest and in accordance with the content of a passenger's parent screen, whether to display a child screen on a driver's parent screen.

[In cases where the display-device-equipped vehicle is moving and the passenger's parent screen is a screen that should not be shown to the driver while the vehicle is moving, it is preferable not to display a child screen on the driver's parent screen by scaling down the passenger's parent screen, or it is preferable to display a substitute image (content display image) for the child screen.

FIG. 11 is a schematic diagram showing the display style of a child screen. As shown in FIG. 11, in cases where the display-device-equipped vehicle is moving and the passenger's parent screen 11 (on the left side in FIG. 11) is a screen that should not be shown to the driver while the vehicle is moving, it is possible for the driver's parent screen 12 (on the right side in FIG. 11) to display, as a child screen, a substitute image 16 indicative of a channel number of the parent screen 11.

Whether or not a child screen is displayed may be determined, for example, by the source mode setting section 2. The source mode setting section 2 only needs to acquire (i) state identification information for identifying whether the display-device-mounted vehicle is moving or at rest and (ii) content identification information for identifying whether the passenger's parent screen may be shown as a child screen to the driver while the display-device-mounted vehicle is moving, and to determine, in accordance with these pieces of identification information, whether or not a child screen is displayed.

Each of the state identification information and the content identification information may be a binarized flag. For example, the state identification information may be a flag that indicates 1 in cases where the vehicle is at rest and 0 in cases where the vehicle is moving and thereby indicates whether the vehicle is moving or at rest, and the content identification information may be a flag that indicates 1 in cases where the passenger's parent screen may be shown to the driver while the vehicle is moving and 0 in cases where the passenger's parent screen must not be shown to the driver while the vehicle is moving. When the value of either of the flags is 1, the source mode setting section 2 only needs to output a child-screen forming command to form a child screen. When not, the source mode setting section 2 only needs to output a child-screen forming command to form no child screen.

Further, the state identification information can be obtained, for example, by connecting the display device 1 to a speedometer of the display-device-equipped vehicle.

Further, the content identification information is based on the content (category) of a parent screen, and only needs to be stored in the form of a table in a memory (not shown) provided in the display device 1. It is preferable that the table be preset before shipment in accordance with legal restrictions or self-restraint, for example, as follows:
DVD moving image: 0
Navigation screen: 1
Menu screen: 1
TV screen: 0
CD operation screen: 0
Radio operation screen: 1
Display of the condition (engine, outside air temperature, air-conditioner setting, or the like) of the vehicle: 1

(where 1 indicates a case where the parent screen may be displayed while the vehicle is moving and 0 indicates a case where the parent screen must not be displayed while the vehicle is moving).

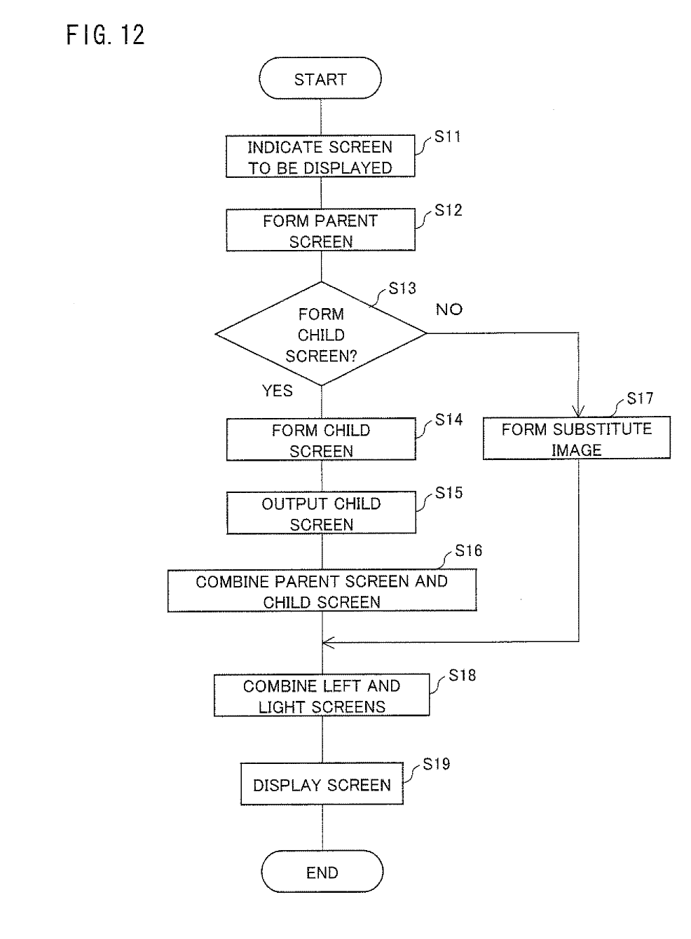

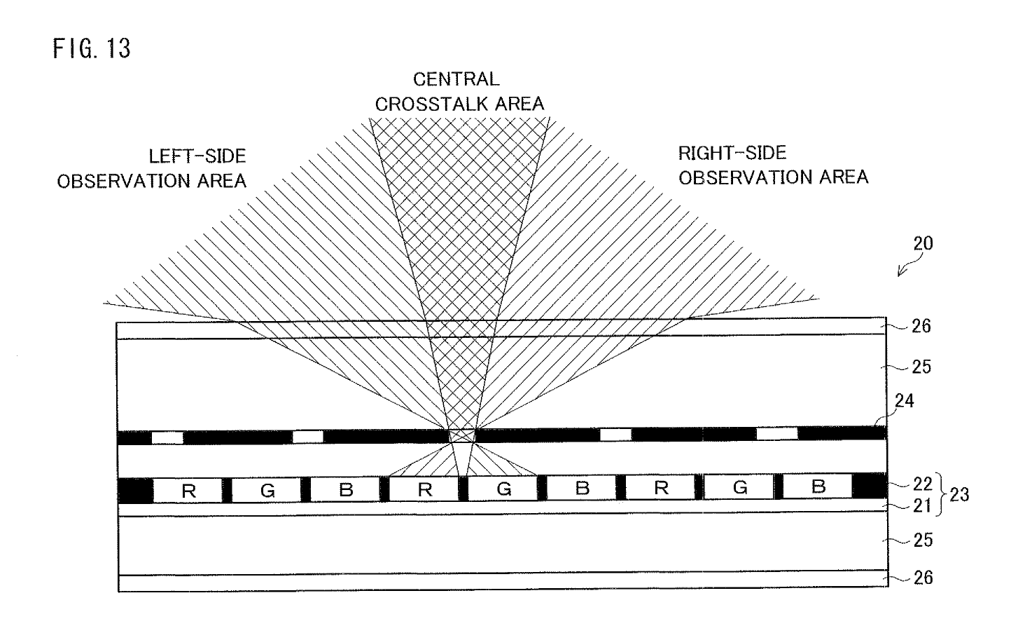

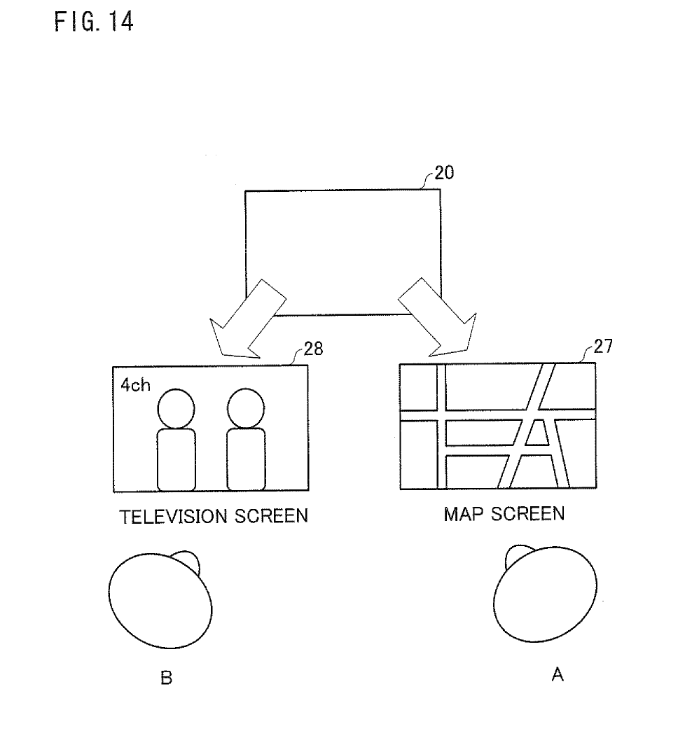

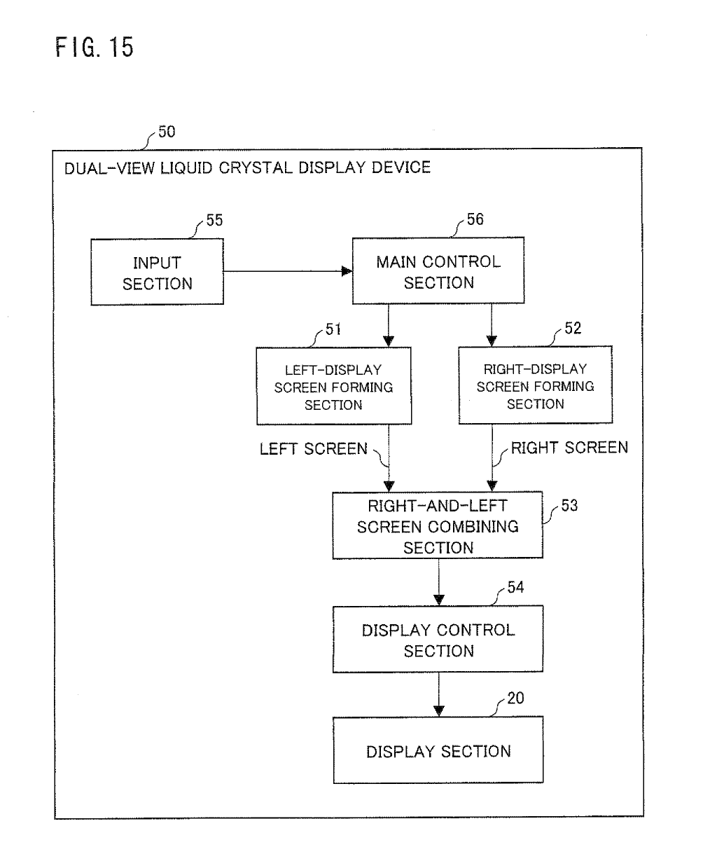

The flow of a process to be performed in displaying a child screen on a driver's parent screen (preventing a child screen from being displayed) is shown in FIG. 12. FIG. 12 is a flow chart showing a modified example of the flow of a process in the display device 1. The flow chart of FIG. 12 differs from the flow chart of FIG. 8 in that the step S17 of forming a substitute image is added in the case of NO in S13, i.e., in cases where no child screen is formed.

The substitute image only needs to be an image containing a character, a number, a figure, or the like that indicates at least part of the content of the parent screen. For example, in cases where the parent screen is an image of a television broadcast, the substitute image may be an image containing a channel number of the television broadcast, or may be an image containing a character indicating that the parent screen is an image of a television broadcast.

Such a substitute image may be stored in a memory (not shown) provided in the display device 1, or may be formed by processing the parent screen into a predetermined image such as a mosaic image or a blurred image.

In cases where there are no such display restrictions as described above, whether a child screen is a screen obtained by scaling down a parent screen or a screen substituting for the parent screen may be determined in accordance with a user's instruction inputted via the input section 9. In accordance with the user's instruction, the source mode setting section 2 outputs a child-screen forming commend containing information indicative of the type of child screen, and each of the screen scaling-down sections 32 and 42 only needs to determines, with reference to the child-screen forming command, whether or not a scaled-down screen is formed.

Each of the screen scaling-down sections 32 and 42 may form a substitute image. That is, each of the screen scaling-down sections 32 and 42 may function as substitute image forming means. Further, it is possible to provide substitute image forming means (not shown) independently of the screen scaling-down sections 32 and 42. Further, there may be such an arrangement that a substitute image is stored in advance in a memory (not shown) provided in the display device 1 and the screen scaling-down sections 32 and 42 or the screen combining sections 33 and 43 obtain the substitute image.

[6-2. Other Modified Examples]

Each block of the display device 1 can be constituted by hardware logic, or may be realized by using a CPU as follows.

That is, the display device 1 includes: a CPU (central processing unit) for executing an instruction of a control program for realizing various functions; a ROM in which the program has been stored; a RAM (random access memory) for expanding the program; and a storage device (recording medium), such as a memory, in which the program and various data are stored. The object of the present invention can also be achieved by providing the display device with a recording medium in which a program code (executable program, intermediate code, or source program) of the control program of the display device 1 has been stored in a computer readable manner, and by causing a computer (CPU or MPU) of the display device 1 to read and execute the program code stored in the recording medium, the program code serving as software for realizing the aforementioned functions.

Examples of the recording medium include: a tape such as a magnetic tape or a cassette tape; a magnetic disk such as a floppy® disk or a hard disk; an optical disk such as a CD-ROM, an MO, an MD, a DVD, or a CD-R; a card such as an IC card (inclusive of a memory card) or an optical card; and a semiconductor memory such as a mask ROM, an EPROM, an EEPROM, or a flash ROM.

Further, the display device 1 may be arranged so as to be connectable to a communication network so that the program code is supplied to the display device 1 through the communication network. The communication network is not particularly limited. Examples of the communication network include, but are not particularly limited to, the Internet, an intranet, an extranet, a LAN, an ISDN, a VAN, a CATV communication network, a virtual private network, a telephone network, a mobile communication network, and a satellite communication network. Further, usable examples of a transmission medium that constitutes the communication network include, but are not particularly limited to, a cable medium such as IEEE 1394, a USB, power line communication, a cable TV line, a telephone line, or an ADSL line and a wireless medium such as IrDA, infrared rays used for a remote controller, Bluetooth®, IEEE 802.11, HDR, a mobile phone network, satellite connection, or a terrestrial digital network. It should be noted that the present invention can also be realized in the form of a computer data signal realized by electronic transmission of the program code and embedded in a carrier wave.

Further, the multiple video display device is preferably arranged such that: the content display image forming section further includes a screen scaling-down section for forming a scaled-down image by scaling down the second screen; and the screen combining section incorporate, as the content display image into the first screen, the scaled-down image formed by the screen scaling-down section.

According to the foregoing arrangement, the screen scaling-down section scales down the second screen, and the screen combining section incorporates the scaled-down second screen into the first screen. This makes it possible to view the scaled-down second screen while viewing the first screen, and to more fully know the content of the second screen.

Further, the multiple video display device is preferably arranged so as to further include a content display image selecting section for determining, in accordance with the content of the second screen, whether or not the scaled-down image is displayed as the content display image.

According to the foregoing arrangement, the content display image selecting section determines, in accordance with the content of the second screen, whether or not the scaled-down image of the second screen is incorporated as the content display image into the first screen. This makes it possible to, when it is not preferable to display the scaled-down image of scaling down the second screen, prevent the scaled-down image from being displayed.

Further, the multiple video display device is preferably arranged so as to further include an input section for receiving an instruction from a user, wherein the screen scaling-down section changes, in accordance with a user's instruction inputted from the input section, a rate at which the second screen is scaled down.

The foregoing arrangement makes it possible to change, in accordance with a user's instruction inputted from the input section, a rate at which the second screen is scaled down. This makes it possible to adjust the size of the scaled-down image of the second screen so that the scaled-down image is easy to view when displayed on the first screen.

Further, the multiple video display device is preferably arranged so as to further include an input section for receiving an instruction from a user, wherein the screen combining section changes, in accordance with a user's instruction inputted from the input section, a position of the content display image on the first screen.

The foregoing arrangement makes it possible to change the position of the content display image in accordance with a user's instruction inputted from the input section. This makes it possible to the content display image in such a position that the content display image is easy to view.

Further, In this case, a screen forming program, operating the multiple video display device, which causes a computer to function as each of the sections and a computer-readable recoding medium containing the screen forming program are encompassed in the technical scope of the present invention.

### INDUSTRIAL APPLICABILITY

The present invention makes it possible to know the content of one display screen image while viewing the other display screen image on a dual-view display device. Therefore, the present invention can be applied to various display devices including dual-view display devices.

1. A multiple video display device for displaying a first screen with respect to a first direction and a second screen with respect to a second direction, comprising:
a content display image forming section for forming a content display image indicative of content of the second screen; and
a screen combining section for incorporating, into the first screen, the content display image formed by the content display image forming section.

2. The multiple video display device as set forth in claim 1, wherein:
the content display image forming section further includes a screen scaling-down section for forming a scaled-down image by scaling down the second screen; and
the screen combining section incorporate, as the content display image into the first screen, the scaled-down image formed by the screen scaling-down section.

3. The multiple video display device as set forth in claim 2, further comprising a content display image selecting section for determining, in accordance with the content of the second screen, whether or not the scaled-down image is displayed as the content display image.

4. The multiple video display device as set forth in claim 2, further comprising an input section for receiving an instruction from a user, wherein
the screen scaling-down section changes, in accordance with a user's instruction inputted from the input section, a rate at which the second screen is scaled down.

5. The multiple video display device as set forth in claim 1, further comprising an input section for receiving an instruction from a user, wherein
the screen combining section changes, in accordance with a user's instruction inputted from the input section, a position of the content display image on the first screen.

6. A screen forming program for operating a multiple video display device as set forth in any one of claims 1 to 5, the screen forming program causing a computer to function as each of the sections.

7. A computer-readable recording medium containing a screen forming program as set forth in claim 6.
